(19) United States
(12) Patent Application Publication
(10) Pub. No.: US 2007/0010184 A1
(43) Pub. Date: Jan. 11, 2007

(54) TOOL WITH A CARRIER PART AND A DISC-SHAPED WORKING PART

(75) Inventors: Markus Stein, Nuembrecht (DE); Nicolas Huth, Lindlar (DE)

Correspondence Address: BARNES & THORNBURG LLP, P.O. BOX 2786, CHICAGO, IL, 60690-2786, US

(73) Assignee: AUGUST RUGGEBERG GMBH & CO. KG, Marienheide (DE)

(21) Appl. No.: 11/428,753

(22) Filed: Jul. 5, 2006

(30) Foreign Application Priority Data
Jul. 5, 2005 (EP) 05014508.5

(51) Int. Cl. B23F 21/03

(52) U.S. Cl. 451/548

(57) ABSTRACT

A tool exhibits a carrier part and a disc-shaped working part for chip-forming machining. The two parts are detachably connected with each other by means of a coupling part and a counter-coupling part that inter-lock. They exhibit convex and concave wall sections adapted to each other. Moreover, there is created a latch-in connection by an inside hexagon aperture and an outside hexagon.

### BACKGROUND OF THE INVENTION

1. Field of the Invention

The invention relates to a tool with a carrier part and a disc-shaped working part for chip-forming machining.

2. Background Art

Tools of the generic type, where a carrier part or a base body are each connected to a working part that is a wear part, are known in diverse embodiments. Working parts of this kind are, for example, abrasive means on a base, polishing discs and cleaning discs or felt discs consisting of needle fleece with an imbedded abrasive means. The carrier part and the working part are rotationally driven. On known embodiments there is fitted on the side opposite to the working side, a coupling part with a female thread, which is screwed onto the thread of a carrier part. Normally, the attaching and detaching of the working part from the carrier part is cumbersome or time-consuming or can only be accomplished the utmost care. This is disturbing because working parts of this kind very often have to be replaced after only a short time of use. Particularly in such a case the stack height of the working parts is also very great because the coupling part with the female thread inevitably exhibits a considerable height.

It is known from EP 1 007 282 B1 that a sheet-formed abrasive means can be attached to a magnetised carrier. For this purpose the abrasive means exhibits a ferromagnetic metal foil. This is unsuitable for the tools of the aforementioned kind.

### SUMMARY OF THE INVENTION

It is an object of the invention to design a generic tool such that the making and breaking of the connection between the carrier part and the working part can be executed in a quick and simple way.

According to the invention this object is achieved by a tool having a carrier part, having a disc-shaped working part for chip-forming machining, and having a common central axis, the carrier part exhibiting an abutting surface for the working part, the working part exhibiting a counter-abutting surface for the abutting surface, the working part exhibiting, concentrically to the central axis, a coupling part having a wall made of alternately arranged first concave wall sections and first convex wall sections passing over into each other, the carrier part exhibiting, concentrically to the central axis, a counter-coupling part adapted to the coupling part, said counter-coupling part having a second wall made of alternately arranged second concave wall sections and second convex wall sections passing over into each other, to accommodate the coupling part, the coupling part exhibiting, concentrically to the central axis, an interlocking rim having an aperture with a polygonal cross-section, said aperture being arranged within the first wall, the counter-coupling part exhibiting, concentrically to the central axis, a shoulder adapted in its cross-section to the aperture, and, on said shoulder, an annular groove adapted to the interlocking rim, the first concave wall section exhibiting a minimum distance R₂₄ from the central axis, the first convex wall section a maximum distance R₂₅ from the central axis, the second concave wall section a minimum distance R₂₉ from the central axis and the second convex wall section a maximum distance R₃₀ from the central axis, the following applying: R₂₅<R₃₀, R₂₄<R₂₉ and R₂₅>R₂₉. The core of the invention is that the working part is placed onto the carrier part, whereby the very flat coupling part of the working part is slid into the counter-coupling part of carrier part. By a simple rotation by a small angle the interlocking rim latches into the annular groove, creating an axially fixed connection between the working part and the carrier part. Regardless of the direction in which the working part is turned with respect to the carrier part, there is a torque-stable connection between the working part and the carrier part because the first convex wall sections of the coupling part come to tangentially abut the second concave wall sections of the counter-coupling part. The torque-stable connection is suitably made by the working part being turned relative to the carrier part in opposite direction to the rotary drive direction of the carrier part until they tangentially abut each other. The working part is then located in a circumferential position relative to the carrier part, which it also assumes when in working use.

Further features, advantages and details of the invention result from the following description of an embodiment example with reference to the drawing.

### BRIEF DESCRIPTION OF THE DRAWING

FIG. 1 shows a top view of a working part with the coupling part of a tool,

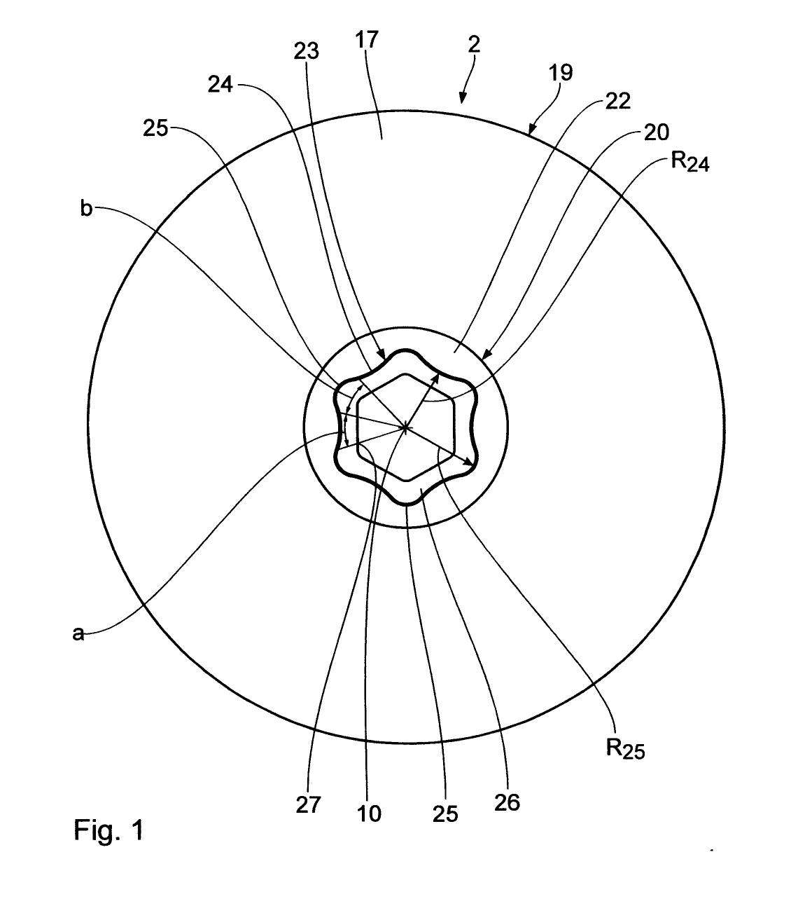

FIG. 2 shows a top view of a carrier part with the counter-coupling part of said tool, and

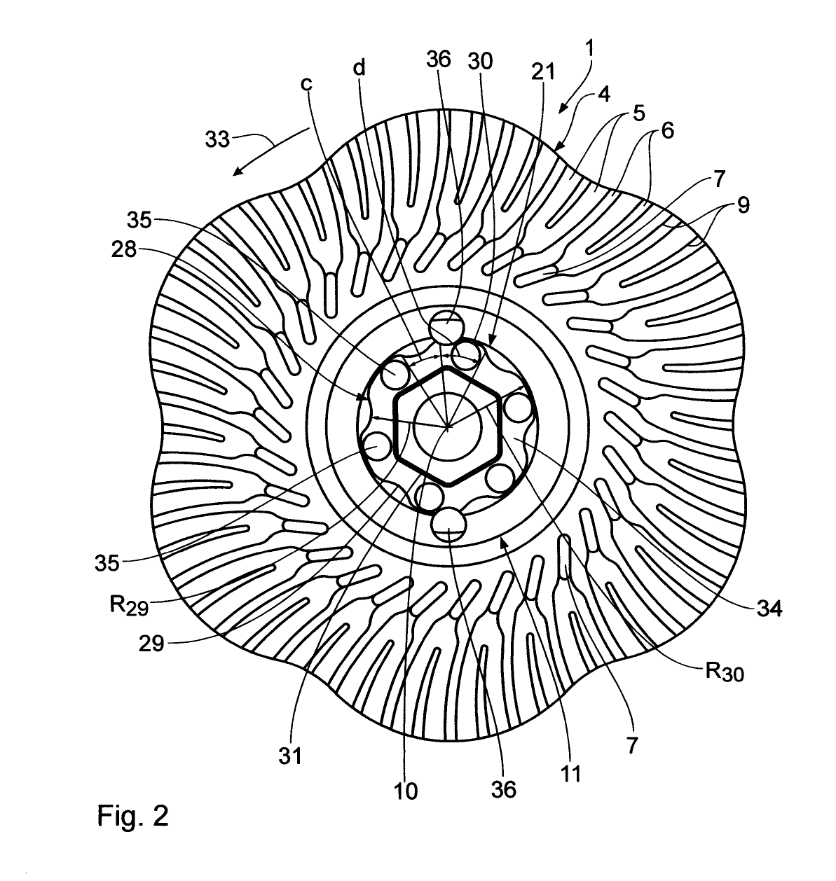

FIG. 3 shows a perspective sectional view through the carrier part with the working part in an exploded view.

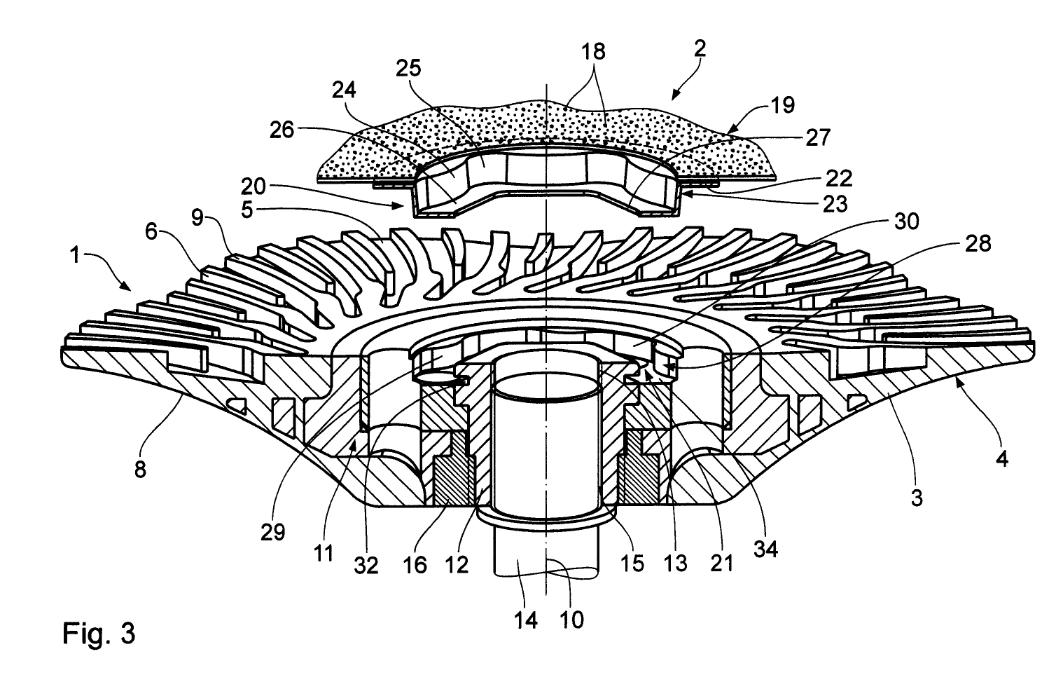

### DESCRIPTION OF A PREFERRED EMBODIMENT

In its basic configuration the tool shown in the drawing consists of a carrier part 1 in the form of a bracing plate and a working part 2. The carrier part 1 exhibits a holding body 3, onto which there is sprayed a carrier plate 4 made of rubber. Said carrier plate 4 is equipped with cooling channels 5 running from the inside to the outside, which are separated from each other by means of ribs 6 also running from the inside to the outside. At their inside end, the cooling channels 5 are each connected to the atmosphere via an air inlet aperture 7 on the back side 8 of the carrier plate 4. The top sides of the ribs 6 opposite to the back side 8 limit an abutting surface 9 for the working part 2. This design of the carrier plate 4 with cooling channels 5 is shown and described in DE 10 2004 009 443 A, to which reference is made.

In the holding body 3, in turn, there is arranged concentrically in relation to a common central longitudinal axis 10 an accommodating body 11, which is non-revolvably, or also revolvably, attached to the holding body 3. Concentrically in relation to the axis 10 there is, in turn, arranged in the accommodating body 11 a drive bushing 12 fitted with a female thread 13. Into this female thread 13 there is screwed a drive shaft 14 of a tool drive, which is not shown, by means of a corresponding male thread 15. Tool drives of this kind can be so-called angle grinders or straight grinders. The accommodating body 11 and the drive bushing 12 are connected with each other in the direction of the axis 10 by means of a ring nut 16 and are abutted firmly against each other and secured against twisting around the axis 10.

The proper working part 2 is designed in the shape of a circular disc, exhibiting a counter-abutting surface 17, which abuts the abutting surface 9 when the working part 2 is attached to carrier part 1. The working part 2 has about the same diameter as the carrier part 1. In the present case, the working part 2 is made up of an abrasive means 18 on a base 19, the counter-abutting surface 17 being formed on that side of base 19 which faces away from the abrasive means 18. Abrasive means 18 of this kind on base 19 are typically made to be not rigid, in other words elastic.

On the working part 2 there is attached a coupling part 20 that is connectable to a counter-coupling part 21 on the carrier part 1. The coupling part 20 exhibits a flange 22 auf, which is glued to the base 19 of the working part 2. Moreover, it exhibits a wall 23 extending approximately in parallel with the central axis 10, which—viewed from the axis 10 to the outside—is made of alternating concave wall sections 24 bent inwards toward axis 10 and convex wall sections 25 bent outwards away from the axis 10. The concave and convex wall sections 24, 25 are arranged alternately, in each case steadily passing over into each other. Any one concave wall section 24 and one neighbouring convex wall section 25 extend over a circumferential angle of 60°. Each section 24 or 25 extends over a circumferential angle of a, or b, of approximately 30°.

On the end of the wall 23 facing away from the flange 22 there is formed on the wall 23 an interlocking rim 26 protruding toward the inside, which exhibits an inside hexagon aperture 27.

The counter-coupling part 21 exhibits a wall 28 auf, which also exhibits alternating concave wall sections 29 and convex wall sections 30, which also steadily pass over into each other and where any one concave wall section 29 and a neighbouring convex wall section 30 extend over a circumferential angle of 60°. Each individual wall section 29, 30 extends over a circumferential angle c, or d, of 30°. The wall 28 is designed as an inside wall in the accommodating body 11.

At the end positioned inside the wall 28, the drive bushing 12 is fitted with a shoulder taking the form of an outside hexagon 31, which is adjusted to the inside hexagon aperture 27 in such a way as to allow the coupling part 20 with its inside hexagon aperture 27 to be slid over outside hexagon 31 with little play. Right below said outside hexagon 31 there is formed inside the drive bushing 12 an annular groove 32, into which the interlocking rim 26 latches after a twist, after the interlocking rim 26 has been slid over outside hexagon 31, thus firmly interlocking the coupling part 20 with counter-coupling part 21 in the direction of the central longitudinal axis 10. In principle the apertures 27 and the shoulder should exhibit a polygonal cross-section.

The maximum radius R₂₅ of the convex wall sections 25 and the minimum radius R₂₄ of the concave wall sections 24 of the wall 23 are measured from the central longitudinal axis 10 to the outside surface of the wall 23. In contrast, the maximum radius R₃₀ of the convex wall sections 30 and the minimum radius R₂₉ of the concave wall sections 29 of the wall 28 are measured from the central longitudinal axis 10 to the inside surface of the wall 28. The maximum radius R₂₅ of the convex wall sections 25 is smaller than the maximum radius R₃₀ of the convex wall sections 30.

The following therefore applies: R₂₅<R₃₀.

It also applies that the minimum radius R₂₄ of the concave wall sections 24 is smaller than the minimum radius R₂₉ of the concave wall sections 29.

The following therefore applies: R₂₄<R₂₉.

The following also applies: R₂₅>R₂₉

There is relatively little play between the wall 23 of the coupling part 20 and the wall 28 of the counter-coupling part 21; it is in the range of 0.1 to 0.3 mm.

Thus, the following applies:
0.1mm≦R₃₀−R₂₅≦0.3mm and 0.1mm≦R₂₉−R₂₄≦0.3mm.

This entails that after the described sliding of the coupling part 20 into the counter-coupling part 21 and after a twist of the coupling part 20 relative to the counter-coupling part 21 by approximately 15° the convex wall sections 30 of the counter-coupling part 21 and the concave wall sections 24 of the coupling part 20 will abut each other, creating a torque-stable connection between the coupling part 20 and the counter-coupling part 21. The twisting movement is thus made over about half the circumferential angle a, b, c, d. The inside hexagon aperture 27 and the outside hexagon 31 are arranged such that they are aligned flush with each other when the coupling part 20 is slid into the counter-coupling part 21.

The coupling connection is made by twisting the working part 2 with the coupling part 20 opposite to the driving direction of rotation 33, so that the torque connection is maintained during operation of the tool.

A floor surface 34 of the counter-coupling part 21 is flush with the annular groove 32. In said floor surface 34, there are arranged permanent magnets 35 holding the interlocking rim 26, which is made of ferromagnetic material, of the coupling part 20 in the direction of the axis 10. These magnets 35 serve to hold carrier part 1 when working part 2 is attached thereto, so that the described twisting movement creating the interlock between the coupling part 20 and the counter-coupling part 21 can also be made by the rotary drive of the tool not until it is used. Moreover, the magnets 35 serve to hold the working part 2 on the carrier part 1 in the event of a quick stop of the driving machine because, given the inertia of the rotating work part 2, unlocking can occur by twisting the working part 2 relative to the carrier part 1 in the direction of rotation 33. Disengagement of the working part 2 from the carrier part 1 in the direction of axis 10 is then prevented by the magnets 35. In the carrier part 1 there are formed apertures 36, through which there may be inserted in each case an appropriate tool to disconnect the carrier part 1 from the drive shaft 14.

What is claimed is:

1. Tool
having a carrier part,
having a disc-shaped working part for chip-forming machining, and
having a common central axis,
the carrier part exhibiting an abutting surface for the working part,
the working part exhibiting a counter-abutting surface for the abutting surface,
the working part exhibiting, concentrically to the central axis, a coupling part having a wall made of alternately arranged first concave wall sections and first convex wall sections passing over into each other,
the carrier part exhibiting, concentrically to the central axis, a counter-coupling part adapted to the coupling part, said counter-coupling part having a second wall made of alternately arranged second concave wall sections and second convex wall sections passing over into each other,
to accommodate the coupling part,
the coupling part exhibiting, concentrically to the central axis, an inter-locking rim having an aperture with a polygonal cross-section, said aperture being arranged within the first wall,
the counter-coupling part exhibiting, concentrically to the central axis,
a shoulder adapted in its cross-section to the aperture, and, on said shoulder, an annular groove adapted to the interlocking rim,
the first concave wall section exhibiting a minimum distance R₂₄ from the central axis, the first convex wall section a maximum distance R₂₅ from the central axis, the second concave wall section a minimum distance R₂₉ from the central axis and the second convex wall section a maximum distance R₃₀ from the central axis, the following applying:
R₂₅<R₃₀,
R₂₄<R₂₉ and
R₂₅>R₂₉.

2. Tool according to claim 1, wherein the following applies:
0.1mm≦R₃₀−R₂₅≦0.3mm and/or
0.1mm≦R₂₉−R₂₄≦0.3mm.

3. Tool according to claim 1, wherein the aperture is designed as an inside hexagon aperture and the shoulder as an outside hexagon.

4. Tool according to claim 1, wherein a first concave wall section and a neighbouring first convex wall section and a second concave wall section and a neighbouring second convex wall section each extend over a circumferential angle of 60°.

5. Tool according to claim 1, wherein in the counter-coupling part there are arranged permanent magnets, to which there are assigned on the coupling part areas made of ferromagnetic material.

6. Tool according to claim 5, wherein the permanent magnets are arranged in a floor surface of the counter-coupling part, said floor surface being designed flush with the annular groove.

7. Tool according to claim 1, wherein the carrier part exhibits a carrier plate and a holding body at least partly enclosed thereby.

8. Tool according to claim 1, wherein the carrier part exhibits a connection for a rotary drive.

9. Tool according to claims 1, wherein the working part is designed as an abrasive means on base.

10. Tool according to claim 1, wherein the carrier plate consists of an elastically yielding material.
